(19) United States
(12) Patent Application Publication
(10) Pub. No.: US 2019/0242174 A1
(43) Pub. Date: Aug. 8, 2019

(54) TRANSMISSION, BOARDING SYSTEM AND RAIL VEHICLE

(71) Applicant: KNORR-BREMSE GESELLSCHAFT MIT BESCHRÄNKTER HAFTUNG, Mödling (AT)

(72) Inventors: Heinz ZARL, Zeillern (AT); Jacob ANGER, Waidhofen/Ybbs (AT)

(21) Appl. No.: 16/330,051

(22) PCT Filed: Aug. 31, 2017
(86) PCT No.: PCT/EP2017/071882

§ 371 Date: Mar. 1, 2019

(30) Foreign Application Priority Data
Sep. 1, 2016 (DE) 10 2016 116 319.8

(51) Int. Cl. E05F 15/635; B61D 19/00; B61D 19/02; F16H 19/04; F16H 19/02; E05F 5/00; E05F 15/641

(52) U.S. Cl. CPC E05F 15/635; B61D 19/005; B61D 19/02; F16H 19/04; E05Y 2900/51; E05F 5/003; E05F 15/641; F16H 2019/046; F16H 19/025

(57) ABSTRACT

The invention relates to a transmission for a boarding system for a rail vehicle, in which the transmission comprises a linearly movable drive shaft for an element of the boarding system, the drive shaft comprising a straight drive region and a curved locking region adjacent thereto, a drive wheel arranged at a distance from the drive shaft, a step-up gear that can move on a circular path around the drive wheel and is coupled to the drive wheel and the drive shaft, and an abutment device for defining a range of movement of the step-up gear between a drive position in the drive region and a locking position in the locking region.

### CROSS REFERENCE AND PRIORITY CLAIM

This patent application is a U.S. National Phase of International Patent Application No. PCT/EP2017/071882, filed Aug. 31, 2017, which claims priority to German Patent Application No. 10 2016 116 319.8, filed Sep. 1, 2016, the disclosure of which being incorporated herein by reference in their entireties.

### FIELD

Disclosed embodiments relate to a mechanism for a boarding system for a rail vehicle, to a boarding system for a rail vehicle, and to a rail vehicle.

### BACKGROUND

In rail vehicles, boarding systems can be moved in their opening direction and closing direction by way of a drive system, and can be locked in a closed position by a locking system.

### SUMMARY

Disclosed embodiments provide an improved mechanism for a boarding system for a rail vehicle, an improved boarding system for a rail vehicle, and an improved rail vehicle.

According to disclosed embodiments, the object is achieved by way of a mechanism for a boarding system for a rail vehicle, a boarding system for a rail vehicle, and a rail vehicle. The mechanism can be of self-locking design. Self-locking mechanisms can be moved only on the drive side under normal operating conditions. Effects of force on the output side within the load limits lead to no movement. A worm gear mechanism can be designed as a self-locking mechanism. The worm gear mechanism may be permanently self-locking in the case of a corresponding selection of the worm.

### BRIEF DESCRIPTION OF THE FIGURES

Exemplary embodiments of the approach proposed here are shown in the drawings and described in greater detail in the following description. In the drawings:

FIG. 1 shows an illustration of a rail vehicle having a boarding system in accordance with one exemplary embodiment,

FIG. 2 shows a diagrammatic illustration of a mechanism in accordance with one exemplary embodiment.

FIG. 3 shows a diagrammatic illustration of a locking movement of a mechanism in accordance with one exemplary embodiment,

FIG. 4 shows a diagrammatic illustration of a locking movement of a mechanism in accordance with one exemplary embodiment, and

FIG. 5 shows a diagrammatic illustration of a locked mechanism in accordance with one exemplary embodiment.

In the following description of favorable exemplary embodiments of the present invention, identical or similar designations are used for the elements which are shown in the various figures and act in a similar manner, a repeated description of the elements being dispensed with.

### DETAILED DESCRIPTION

In the case of the approach which is proposed here, the drive takes place by way of a rotational movement. At the output, at least one element of a boarding system, for example a door panel of a sliding door system or a swiveling/sliding door system, is moved with a linear movement. A virtual toggle lever is extended or overextended in the closed position. The linear action of force from the output side is blocked by way of the extended or overextended toggle lever. As a result, the mechanism is self-locking only at the one point, and can also be moved manually, for example, in the case of emergency unlocking.

A mechanism for a boarding system for a rail vehicle is proposed, the mechanism having the following features:

a movable drive rod for an element of the boarding system, the drive rod having a straight drive region and a curved locking region which adjoins the latter;

a drive wheel which is arranged spaced apart from the drive rod;

a transmission wheel which can be moved on a circular path around the drive wheel and is coupled to the drive wheel and the drive rod; and

a stop device for limiting a movement range of the transmission wheel between a drive position on the drive region and a locking position on the locking region.

A boarding system can be understood to mean a sliding door system or swiveling/sliding door system for a rail vehicle. An element can be a door panel or a step. The element is moved to and fro in a movement direction between two end positions. The end positions can be called an open position and a closed position. The drive rod can be coupled to the element and can likewise be moved in the movement direction. In the closed position, a seal device can be compressed and can provide a counterpressure against a drive force of a motor of the boarding system. The movable curved locking region, the movable transmission wheel and the fixed drive wheel configure a toggle lever which is angled away in the drive position and is extended or overextended at least approximately in the locking position.

The drive rod can be a rack. The transmission wheel and the drive wheel can be gearwheels. The mechanism can be free from slip as a result of a toothing system. High actuating forces can be transmitted by way of the toothing system.

The drive rod can have a raceway. The transmission wheel and the drive wheel can be friction wheels. Vibrations and/or noise of the mechanism and/or the drive train can be reduced by way of a pure rolling movement. The friction wheels and/or the raceway can have an elastic coating which has a damping effect.

The locking region of the drive rod can be configured as a circular segment. The circular segment can run tangentially into the drive region. As a result, a jolt-free transition from the drive region to the locking region can be achieved.

The drive rod can be moved in a linear manner in a movement direction of the element.

The drive rod can be moved in a movement direction of the element and transversely with respect to the movement direction. The drive rod can carry out the locking movement by way of the transverse movability.

The transmission wheel can be mounted in a connecting rod. The connecting rod can be mounted such that it can be rotated about an axis of the drive wheel. The transmission wheel is guided on its circular path by way of the connecting rod. Exact guidance on the circular path can be achieved by way of the connecting rod.

The stop device can have a drive stop and a locking stop for the connecting rod. The stops can be damped. The movement range of the transmission wheel can be limited simply and inexpensively by way of stops.

The transmission wheel can run through a dead center on its circular path between the drive position and the locking position. At the dead center, a contact point between the drive rod and the transmission wheel, a center point of the transmission wheel and a center point of the drive wheel can be oriented in one axis. The dead center can be arranged between the drive position and the locking position. A directional reversal of the movement direction of the drive rod takes place at a dead center. The mechanism is self-locking as a result of the dead center.

The mechanism can have a further linearly movable element, for example a further door panel of the sliding door system. The further door panel can be capable of moving in the opposite direction to the door panel. The further drive rod can have a further straight drive region and a further curved locking region which adjoins the latter. The mechanism can have a further transmission wheel which can be moved on the circular path around the drive wheel. The further transmission wheel can be coupled to the drive wheel and the further drive rod. The drive wheel can be arranged between the drive rod and the further drive rod. The further transmission wheel can be arranged diametrically opposite the transmission wheel. A further door panel of the sliding door system can be moved and locked using the same drive by way of the further drive rod and the further transmission wheel.

Furthermore, a boarding system for a rail vehicle is proposed, the boarding system having a mechanism in accordance with the approach proposed here, an element of the boarding system being coupled to the drive rod.

Furthermore, a rail vehicle having a boarding system in accordance with the approach proposed here is proposed.

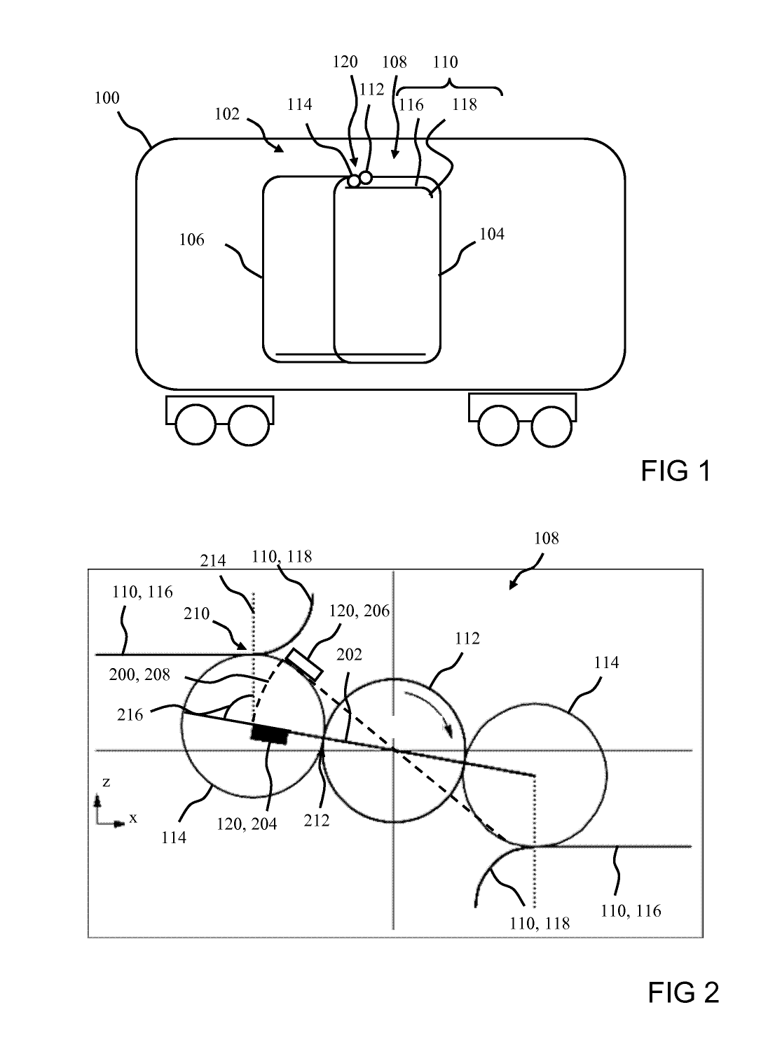

FIG. 1 shows an illustration of a rail vehicle 100 having a boarding system 102 in accordance with one exemplary embodiment. The boarding system 102 has an element 104 which can be moved in a vehicle longitudinal direction or x-direction. Here, the boarding system 102 is a sliding door system 102. As the element 104, the sliding door system 102 has a door panel 104 which can be moved in the x-direction. If the door panel 104 is closed or is arranged in a closed position, the door panel 104 closes a doorway 106 of the rail vehicle 100. The boarding system 102 can also have a step 104 as a movable element 104. For driving and locking, the boarding system 102 has a mechanism 108 in accordance with the approach proposed here. The mechanism 108 has a drive rod 110 which is coupled to the element 104. The drive rod 110 can be moved at least in the movement direction of the element 104. Furthermore, the mechanism has a rotatably mounted drive wheel 112 which is fixed on the doorway or the vehicle, and a transmission wheel 114.

The drive wheel 112 is coupled to a drive (not shown here) of the boarding system 102, for example an electric motor. The transmission wheel 114 is coupled to the drive wheel 112 and the drive rod 110. The drive wheel 112 transmits its rotation to the transmission wheel 114. The transmission wheel 114 rolls on the drive rod 110 and converts a rotation into a translation.

The transmission wheel 114 is mounted such that it can be moved on a circularly arcuate path around the drive wheel 112. For example, a rotational axle of the transmission wheel 114 can be guided in a circularly arcuate slotted guide.

The drive rod has a rectilinear drive region 116 which is oriented in the movement direction of the door panel 104, and a curved locking region 118 which adjoins the drive region 116. During closing of the door panel 104, the transmission wheel 114 rolls on the drive region 116, in order to move the door panel in the movement direction or a closing direction. Here, the transmission wheel 114 is held in a drive position by way of a stop device 120 of the mechanism 108.

Just before the door panel 104 reaches the closed position, the transmission wheel 114 rolls from the drive region 116 onto the locking region 118. Here, the transmission wheel 114 moves on its circularly arcuate path out of the drive position. The transmission wheel 114 reaches a dead center approximately in the closed position. At the dead center, the transmission wheel 114 is arranged exactly between the locking region 118 and the drive wheel 112. The dead center marks a vertex of the movement of the door panel 104. At the dead center, a first contact point between the drive rail 110 and the transmission wheel 114 and a second contact point between the transmission wheel 114 and the drive wheel 112 lie diametrically opposite one another on the transmission wheel 114.

At the dead center or just after the dead center, the transmission wheel 114 is held in a locking position by way of the stop device 120. In the locking position, the transmission wheel 114 prevents an opening movement of the door panel 104 in a self-locking manner.

In order to open the door panel 104, a rotational direction of the drive wheel 112 is reversed. The transmission wheel 114 then rolls from the locking region 118 onto the drive region 116, and is again held in the drive position by the stop device 120, in order to move the door panel 104 in the movement direction or an opening direction.

The following advantages result from the approach which is proposed here. An integral overall design is achieved by way of a reduction of components, by the functions of drive and locking being combined in one module 108. The proposed mechanism has a simple functional principle and a reduced installation space requirement. The principle can be applied fundamentally to sliding doors 102, swiveling/sliding doors and steps. The installed position of the drive is fundamentally arbitrary. The drive can fundamentally be positioned as desired in the Z-direction and Y-direction relative to the door panel 104 via a variable connecting element between the drive rod 110 and the door panel 104. The proposed mechanism 108 is substantially maintenance-free and has a free transmission ratio selection.

FIG. 2 shows a diagrammatic illustration of a mechanism 108 in accordance with one exemplary embodiment. Here, the mechanism 108 corresponds substantially to the mechanism in FIG. 1. In contrast to this, the mechanism 108 is configured as a drive and locking mechanism for two door panels which move in opposite directions of a sliding door system in accordance with the approach which is proposed here. To this end, the mechanism comprises a further drive rod 110 and a further transmission wheel 114. The transmission wheels 114 are arranged on the circularly arcuate path 200 so as to lie diametrically opposite one another, and are connected to one another via a connecting rod 202. Here, the connecting rod 202 connects the bearing points of the transmission wheels 114 to one another. The connecting rod 202 is mounted centrally between the bearing points coaxially with respect to the drive wheel 112.

In the exemplary embodiment which is shown, the transmission wheels 114 have approximately the same diameter as the drive wheel 112. The transmission wheels 114 can also be larger or smaller than the drive wheel 112.

Here, the stop device 120 has a drive stop 204 for the drive position and a locking stop 206 for the locking position. The stops 204, 206 bear against the connecting rod 202. The connecting rod 202 can be moved between the two stops 204, 206. In other words, the stops 204, 206 limit a movement range 208 of the transmission wheels 114 on the circularly arcuate path 200.

Here, the transmission wheels 114 are arranged at a transition point between the drive region 116 and the locking region 118 of the drive rod 110. The locking region 118 is configured as a circular segment. The connecting rod 202 bears against the drive stop 204. The transmission wheels 114 are in the drive position. Here, a first contact point 210 between the drive rod 110 and the transmission wheel 114 lies at the transition point. A second contact point 212 between the transmission wheel 114 and the drive wheel 112 lies between the bearing points of the transmission wheel 114 and the drive wheel 112.

At the transition point, the transmission wheel 114 configures a first virtual lever arm 214 with the locking region 118. The first virtual lever arm 214 runs from the pivot point of the transmission wheel 114 through the first contact point 210 to a local curvature center point of the locking region 118 at the first contact point 210. Here, the curvature center point is the center point of a radius of the circular segment. The first virtual lever arm 214 configures a virtual toggle lever joint together with a second virtual lever arm between the pivot point of the transmission wheel 114 and the pivot point of the drive wheel 112. In the case of the toggle lever joint, the force ratios are dependent on an angle 216 between the first virtual lever arm 214 and the second virtual lever arm.

In other words, FIG. 2 shows a linear drive 108 including a locking mechanism. The drive which is shown here can be used as a drive and locking mechanism in the case of a rack or rod drive of boarding systems. The drive unit comprising the drive wheel 112, the transmission wheels 114 and the connecting rod 202 takes over both the drive of the door panels and the locking action. A situation just before the closed position is shown.

The drive takes place by the drive wheel 112 via a corresponding direct drive or a motor/gear unit. As a result, the transmission wheels 114 are driven which displace the drive rod 110 in the opposite direction. The door panels are connected to the drive rods 110. A change of the drive rods 110 leads directly to a change of the door panel position. By way of the rotational movement in the clockwise direction or counter to the clockwise direction of the drive wheel 112, the drive train is locked in a predefined position and a movement of the door panel is prevented. This typically takes place when the door panels are situated in the closed position. As a result, the system is closed and locked or open. The transmission of force from the drive wheel 112 to the transmission wheels 114 and/or to the drive rod 110 can take place via gearwheels or friction wheels.

The open stop 204 or drive stop 204 which is shown serves as a positional stop of the transmission wheels 114, and prevents the transmission wheels 114 from moving into an undefined position. Every desired transmission ratio can be set by way of a free selection of the diameters of the drive wheel 112 and the transmission wheels 114.

A circular segment 118 is arranged at the end of the drive rod 110 in front of the closed position.

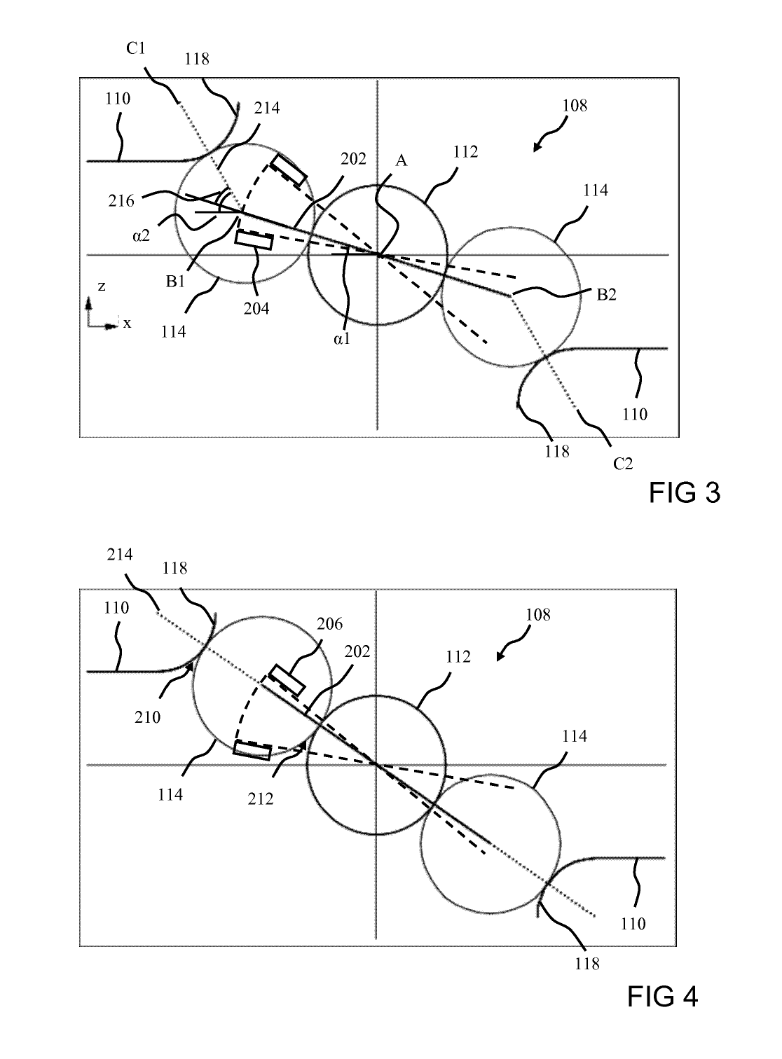

FIG. 3 shows a diagrammatic illustration of a locking movement of a mechanism 108 in accordance with one exemplary embodiment. The mechanism 108 corresponds substantially to the mechanism in FIG. 2. Here, the transmission wheels 114 are arranged in the locking regions 118 of the drive rods 110. The connecting rod 202 has moved away from the drive stop 204.

The angle 216 between the first virtual lever arm 214 and the second virtual lever arm becomes smaller as a result of the movement of the transmission wheels 114 on the curved surface of the locking regions 118. A transmission ratio of the toggle lever joint changes as a result of the reduced angle 216.

In other words, FIG. 3 shows the situation at the beginning of the rotation of the connecting rod 202. Just before the closed position, the force on the drive rod 110 increases on account of inherent forces in the system, such as a pressure of the finger guard rubber strip. The components of connecting rod 202 and transmission wheels 114 begin to rotate about the y-axis as a result of the increasing force on the drive rod 110 and the degree of freedom in the transmission wheels 114 which permits a rotation about the y-axis.

The movement of the wheels 114 and the drive rod 202 can be described mathematically via a three lever system which is connected to one another or mounted via the joints A, B, C.

A lever which is called the connecting rod 202 in the specific case is mounted in a stationary manner centrally at the pivot point A and has a length L1. The length L1 is given by the radii RA, RÜ of the drive wheel 112 and the transmission wheel 114. L1=2*(RÜ+RA) then applies to the entire connecting rod 202. The pivot center point A of the connecting rod 202 can be described by L1/2.

As soon as the transmission wheels 114 are in engagement with the circular segments 118, the center points B1, B2, C1, C2 of the transmission wheels 114 and the circular segments 118 are at a constant spacing L2 which is defined via the radii RÜ, RK of the transmission wheels 114 and the circular segments 118. The spacing L2=RÜ+RK. This results in two further imaginary levers 214 for the mathematical description.

The joints at the points C1, C2 are fixed in the z-direction and can be displaced exclusively in the x-direction. The origin of the coordinate system is placed at the point A for the calculation. Only the left-hand side, that is to say the points A, B1, C1, is considered for the mathematical description; the second half can be described by way of an algebraic sign change with the same equations.

The x-position of the point B1 results in a manner which is dependent on the rotational angle α1 of the connecting rod 202. B1(x)=−L1/2*cos(α1). The z-position of the point B1 results in a manner which is dependent on the rotational angle α1 of the connecting rod 202. B1(z)=L1/2*sin(α1). The x-position of the point C1 results in a manner which is dependent on the position of the point B1. C1,x=B1,x−L2*cos(α2), wherein α2 is the rotational angle of the imaginary lever 214. α2=arcsin((C1(z)−B1(z))/L2). The relative z-displacement of the point C1 is zero. C1(z)=const. The dead center is reached at α1=α2. The position beyond the dead center is reached at α1>α2.

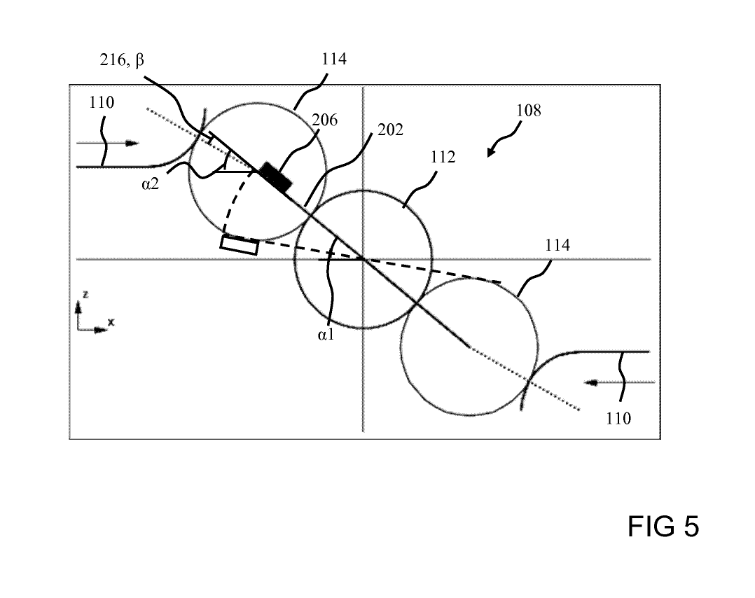

FIG. 4 shows a diagrammatic illustration of a locking movement of a mechanism 108 in accordance with one exemplary embodiment. The mechanism 108 corresponds substantially to the mechanism in FIGS. 2 and 3. The transmission wheels 114 are likewise arranged in the locking regions 118 of the drive rods 110. The connecting rod 202 has reached the dead center. The contact points 210, 212 lie in one line with the bearing points and the rotational axis of the drive wheel 112. The connecting rod 202 is at a small spacing from the locking stop 206. At the dead center, the first virtual lever arm 214 and the second virtual lever arm are arranged in a direct extension. Therefore, the toggle lever joint is extended or has reached its dead center position.

In one exemplary embodiment, the elements 110 have a degree of freedom in the z-coordinate. For example, at least the locking regions 118 are mounted movably in the z-direction. Here, the drive wheel 112 can engage directly into the drive rods 110, as a result of which the transmission wheels 114 and the connecting rod 202 can be dispensed with. If the engaging wheel rolls on the locking regions 118, the locking regions 118 are moved in the z-direction. For example, part regions of the drive rods 110 can be moved with the locking regions 118 via a rotary joint substantially in the z-direction. This then results in the virtual toggle lever joint between the pivot point of the drive wheel 112 and the rotary joint. At least the locking regions 118 can likewise be guided in a linear manner in the z-direction. A self-locking position is achieved when the engaging wheel reaches the end of the locking region 118. A movement of the drive rods 110 in the x-direction is then blocked. Therefore, the locking operation is initiated at a predefined position by way of lifting or lowering of the elements 110.

FIG. 5 shows a diagrammatic illustration of a locked mechanism 108 in accordance with one exemplary embodiment. The mechanism 108 corresponds substantially to the mechanism in FIGS. 2 to 4. The connecting rod 202 has passed the dead center and bears against the locking stop 206. Here, the toggle lever joint is overextended and the angle 216 is negative. In order to reach the dead center again, force is required. As a result, the mechanism 108 is self-locking.

What is known as the angle beyond the dead center β=α1−α2 (position beyond the dead center at β>0°) can be selected freely. It is to be ensured, however, that C1(x) has a minimum and C2(x) has a maximum in the dead center position. In order to move the system out of the position beyond the dead center, C1(x) is moved in the negative x-direction as far as the dead center position. In order to keep the force requirement of the drive unit as low as possible, the displacement can be selected to be as low as possible. In the case of a constant moment MÜ on the transmission wheel 114, the x-force FC1(x) which can act on the drive rod 202 is dependent on the angle α2. FC1(x)=MU/RÜ*sin(α2). The force FC1(x) should not become too low, in order to move the system 108 out of the beyond center position securely. The radii RA, RÜ and the angle α1 determine the installation space requirement in the z-direction.

By way of the driving of the drive wheel 112, the system 108 can be rotated as far as into a dead center position and beyond.

As soon as the dead point position is passed, the x-force from the drive rod 110, for example by way of a pressure of the finger guard rubber strip, causes a moment on the connecting rod 202 about the axis of the drive wheel 112. Forces from the drive rod 110 cannot lead to tipping back of the connecting rod 202 from the position beyond the dead center. Therefore, the system 108 is self-locking.

The locking stop 206 limits the maximum possible position beyond the dead center at an angle of β>0°. In addition, a spring can secure the locked position. The locked position is the stable position of the system 108.

In one exemplary embodiment, the locking takes place without a position beyond dead center and/or with lower forces on the wheels 112, 114. The rotation by the connecting rod 202 can likewise be utilized to rotate a locking lever and to lock the door system by way of the component.

### LIST OF DESIGNATIONS

100 Rail vehicle

102 Sliding door system

104 Door panel

106 Doorway

108 Mechanism

110 Drive rod

112 Drive wheel

114 Transmission wheel

116 Drive region

118 Locking region

120 Stop device

200 Circular arc path

202 Connecting rod

204 Drive stop

206 Locking stop

208 Movement range

210 First contact point

212 Second contact point

214 Virtual lever arm

216, β Resulting angle

A Pivot point, drive wheel, joint

B Pivot point, transmission wheel, joint

C Pivot point, imaginary lever, joint

α1 Angle of the connecting rod

α2 Angle of the imaginary lever

1. A mechanism for a boarding system for a rail vehicle, the mechanism comprising:
a movable drive rod for an element of the boarding system, the drive rod having a straight drive region and a curved locking region which adjoins the latter;
a drive wheel which is arranged spaced apart from the drive rod;
a transmission wheel which can be moved on a circular path around the drive wheel and is coupled to the drive wheel and the drive rod; and
a stop device for limiting a movement range of the transmission wheel between a drive position on the drive region and a locking position on the locking region.

2. The mechanism of claim 1, wherein the drive rod is a toothed rack, and the transmission wheel and the drive wheel are gearwheels.

3. The mechanism of claim 1, wherein the drive rod has a raceway, and the transmission wheel and the drive wheel are friction wheels.

4. The mechanism of claim 1, wherein the locking region of the drive rod is configured as a circular segment.

5. The mechanism of claim 1, wherein the drive rod is movable in a linear manner in a movement direction of the element.

6. The mechanism of claim 1, wherein the drive rod is movable in a movement direction of the element and transversely with respect to the movement direction.

7. The mechanism of claim 1, wherein the transmission wheel is mounted in a connecting rod which is mounted such that it can be rotated about an axis of the drive wheel.

8. The mechanism of claim 7, wherein the stop device has a drive stop and a locking stop for the connecting rod.

9. The mechanism of claim 1, wherein the transmission wheel runs through a dead center on its circular path between the drive position in the locking position, in which dead center a contact point between the drive rod and the transmission wheel, a center point of the transmission wheel and a center point of the drive wheel are oriented in one axis, the dead center being arranged between the drive position and the locking position.

10. The mechanism of claim 1, further comprising a further linearly movable drive rod for a further element of the boarding system, wherein the further drive rod has a further straight drive region and a further curved locking region which adjoins the latter, the mechanism having a further transmission wheel which is movable on the circular path around the drive wheel, the further transmission wheel being coupled to the drive wheel and the further drive rod, the drive wheel being arranged between the drive rod and the further drive rod, and the further transmission wheel being arranged diametrically opposite the transmission wheel.

11. A boarding system for a rail vehicle, the boarding system having a mechanism as claimed in claim 1, wherein the element of the boarding system is coupled to the drive rod.

12. A rail vehicle having a boarding system as claimed in claim 11.
